(19) United States
(12) Patent Application Publication
(10) Pub. No.: US 2026/0262704 A1
(43) Pub. Date: Sep. 10, 2026

(54) AEROSOL-GENERATING ARTICLE WITH CAVITY

(71) Applicant: Philip Morris Products S.A., Neuchatel (CH)

(72) Inventors: Matteo BOLOGNA, Lausanne (CH); Bruno Christian Joseph CHASSOT, Auvernier (CH); Onur DAYIOGLU, Neuchatel (CH); Marie Rose Danielle FARINE, Sugiez (CH); Jerome UTHURRY, Neuchatel (CH)

(73) Assignee: Philip Morris Products S.A., Neuchatel (CH)

(21) Appl. No.: 19/135,412

(22) PCT Filed: Dec. 21, 2023
(86) PCT No.: PCT/EP2023/087247

§ 371 Date: Jun. 4, 2025

(30) Foreign Application Priority Data
Dec. 23, 2022 (EP) 22216422.0

(51) Int. Cl. A24D 1/20; A24F 40/20; A24F 40/42; A24F 40/485

(52) U.S. Cl. CPC A24D 1/20; A24F 40/42; A24F 40/485; A24F 40/20

(57) ABSTRACT

An aerosol-generating article is provided, including: an aerosol-forming material; first and second planar layers respectively extending in first and second planes; the second plane parallel to and spaced from the first plane, the article defined by an article length, width, and thickness respectively extending in x, y, and z directions, the thickness extending perpendicular to the first and second planes, a cavity being defined between the first and second planar layers, an airflow passage being defined through the article between an air flow inlet and outlet and extending through the cavity, a cavity height defined by a distance between a lower surface of the first layer and an upper surface of the second layer, the thickness being less than 5 mm and the cavity height being greater than 50 percent of the thickness, an airflow path being defined through the article from the inlet, through the cavity, to the outlet.

The present disclosure relates to an aerosol-generating article comprising an aerosol-forming material.

A typical aerosol-generating article may appear similar to a conventional cigarette. For example, such an aerosol-generating article may be a substantially cylindrical article comprising an aerosol-forming substrate and other components such as mouthpiece filter element, all wrapped in a cigarette paper. Dimensions of typical aerosol-generating articles are often similar to the dimensions of conventional cigarettes.

Research has shown that, in such a typical aerosol-generating article comprising a plug of aerosol-forming substrate, a significant portion of the plug of aerosol-forming substrate may not be sufficiently heated to form an aerosol during use. This is undesirable since this portion of the plug of aerosol-forming substrate contributes to the cost of manufacture and transport of the aerosol-generating article, but does not contribute to the aerosol delivered to an end user. This may be the case regardless of the way in which the aerosol-forming substrate is heated, for example regardless of whether a resistive or inductive heater is used and regardless of whether the plug of aerosol-forming substrate is heated from the inside or the outside.

It is an aim of the present disclosure to provide an aerosol-generating article, in which a greater portion of an aerosol-forming substrate of the aerosol-generating article is sufficiently heated to form an aerosol during use.

According to the present disclosure, there may be provided an aerosol-generating article comprising an aerosol-forming material for producing an aerosol. The aerosol-forming article may comprise a first planar layer extending in a first plane and a second planar layer extending in a second plane, the second plane being parallel to and spaced from the first plane. A thickness of the aerosol-generating article may extend in a direction perpendicular to the first plane and the second plane, in which a cavity is defined between the first planar layer and the second planar layer. A height of the cavity may be defined by the distance between a lower surface of the first planar layer and an upper surface of the second planar layer. The thickness of the aerosol-generating article may be less than 5 millimetres. The height of the cavity may be greater than 50 percent of the thickness of the aerosol-generating article.

According to the present disclosure, there may be provided an aerosol-generating article comprising an aerosol-forming substrate for producing an aerosol, the aerosol-generating article being a planar aerosol-generating article having a base defined by a length extending in an x direction, a width extending in a y direction, and a height extending in a z direction. The aerosol-forming article may comprise a first planar layer extending in a first plane and a second planar layer extending in a second plane, the second plane being parallel to and spaced from the first plane. A thickness of the article may extend in a direction perpendicular to the first plane and the second plane, in which a cavity is defined between the first planar layer and the second planar layer. A height of the cavity may be defined by the distance between a lower surface of the first planar layer and an upper surface of the second planar layer. The thickness of the aerosol-generating article may be less than 5 millimetres. The height of the cavity may be greater than 50 percent of the thickness of the aerosol-generating article.

According to the present disclosure, there may be provided an aerosol-generating article comprising an aerosol-forming substrate for producing an aerosol, the aerosol-generating article comprising a substantially planar upper surface defined by a length extending in an x direction and a width extending in a y direction, and a substantially planar lower surface defined by a length extending in an x direction and a width extending in a y direction. The substantially planar upper surface and the substantially planar lower surface may be vertically spaced from each other by a height defined in a z direction. The aerosol-generating article may comprise a first planar layer extending in a first plane and a second planar layer extending in a second plane. The first planar layer may comprise the substantially planar upper surface and a lower surface of the first planar layer. The second planar layer may comprise the substantially planar lower surface and an upper surface of the second planar layer. A thickness of the aerosol-generating article may extend in a direction perpendicular to the first plane and the second plane, in which a cavity is defined between the first planar layer and the second planar layer. A height of the cavity may be defined by the distance between the lower surface of the first planar layer and the upper surface of the second planar layer. The thickness of the aerosol-generating article may be less than 5 millimetres. The height of the cavity may be greater than 50 percent of the thickness of the aerosol-generating article.

The aerosol-generating article of the present disclosure may be generally flat and thin, for example having a thickness of less than 5 millimetres. Advantageously, the provision of a generally flat and thin aerosol-generating article provides for rapid and efficient heating of aerosol-forming material in the aerosol-generating article and improved uniformity in through-thickness heating.

Advantageously, the cavity height is relatively tall, for example the height of the cavity may be greater than 50 percent of the thickness of the aerosol-generating article. The provision of a cavity height that is generally tall provides space for adequate airflow through the aerosol-generating article despite the article being generally flat and thin. The cavity height may allow, in use, air to flow more slowly through the cavity compared to cavity having a lesser height, thereby providing improved contact between the air flow and aerosol-forming material of the aerosol-forming article, enhanced mixing of generated aerosol and air in the cavity, and improved aerosolisation.

The thickness of the aerosol-generating article may be defined by the distance between an upper surface of the aerosol-generating article and a lower surface of the aerosol-generating article. For example, a thickness of the aerosol-generating article may be defined between an upper surface of the first planar layer, for example a substantially planar upper surface of the first planar layer, and a lower surface of the second planar layer, for example a substantially planar lower surface of the second planar layer.

The first planar layer may comprise the upper surface the aerosol-generating article and a lower surface the aerosol-generating article, wherein the upper surface and lower surface may be vertically spaced from each other by a height defined in a z direction. The upper surface of the first planar layer may be substantially planar and defined by a length extending in an x direction and a width extending in a y direction. The lower surface of the first planar layer may be substantially planar lower surface and defined by a length extending in an x direction and a width extending in a y direction. The upper surface of the first planar layer may be an external upper surface of the aerosol-generating article.

The second planar layer may comprise an upper surface and the lower surface, wherein the upper surface and lower surface may be vertically spaced from each other by a height defined in a z direction. The upper surface of the second planar layer may be substantially planar and defined by a length extending in an x direction and a width extending in a y direction. The lower surface of the second planar layer may be substantially planar lower surface and defined by a length extending in an x direction and a width extending in a y direction. The lower surface of the second planar layer may be an external lower surface of the aerosol-generating article.

Advantageously, the upper external surface of the first planar layer and the lower external surface of the second planar layer allow for good contact with an external heater, particularly a planar external heater, of an aerosol-generating device, thereby providing optimum heating of the aerosol-generating substrate.

Advantageously, the upper external surface of the first planar layer and the lower external surface of the second planar layer may provide a large surface area for heating by an external heater of an aerosol-generating device, thereby allowing the aerosol-generating substrate to be quickly heated to a temperature sufficient for generating an aerosol.

Aerosol-generating articles according to the present disclosure may preferably be substantially flat articles or substantially planar articles. Such articles have a large base area relative to the volume of the article. Advantageously, a larger base area may provide greater surface area for heating by a planar heater of an aerosol-generating device. Advantageously, a smaller height may allow a smaller temperature gradient or difference across the height of the aerosol-generating article during heating. For example, where the base of the aerosol-generating article is in contact with, and heated by, a planar heater, there may be a smaller temperature difference between the base and an upper surface opposing the base if the spacing, or height, between the base and the upper surface is smaller. Advantageously, this may allow heating of a greater proportion of the aerosol-forming substrate of the aerosol-generating article to a temperature at which an aerosol is released, whilst minimising the risk of burning the hottest portion of the substrate closest to the heater. Alternatively, or in addition, this may reduce a time required to heat the aerosol-forming substrate sufficiently to release an aerosol.

The aerosol-generating article may comprise an air flow inlet, an air flow outlet and an airflow passage extending between the air flow inlet and the air flow outlet. The airflow passage may extend between the air inlet and the air outlet through the cavity.

The aerosol-generating article may be defined by an article length extending in an x direction, an article width extending in a y direction, and an article thickness extending in a z direction, in which the air flow passage may be defined through the aerosol-forming article between the air flow inlet and the air flow outlet, the air flow passage flowing through the cavity. For example, the airflow passage may extend between the air inlet and the air outlet through the cavity.

The air flow inlet may be defined by an inlet width and an inlet height, in which the inlet width is greater than 80 percent of the article width, and the inlet height is greater than 25 percent of the article height, optionally in which the air flow inlet is substantially rectangular.

The air flow outlet may be defined by an outlet width and an outlet height, in which the outlet width is greater than 80 percent of the article width, and the outlet height is greater than 25 percent of the article height, optionally in which the air flow outlet is substantially rectangular.

Advantageously, the air inlet dimensions may facilitate air flow into the aerosol-generating article. The air outlet dimensions may facilitate air flow out of the aerosol-generating article.

The height of the cavity may be greater than 60 percent of the thickness of the article, for example greater than 70 percent of the thickness of the article, for example greater than 80 percent of the thickness of the article, preferably greater than 85 percent of the thickness of the article, or greater than 90 percent of the thickness of the article, for example greater than 95 percent of the thickness of the article.

The air flow inlet may be defined at a distal end of the article, the air flow inlet may be configured to allow air to flow into the cavity. The air flow outlet may be defined at a proximal end of the article, the air flow outlet may be configured to allow air to flow out of the cavity.

The aerosol-generating article may further define a mouthpiece in fluid communication with the cavity, for example an integral mouthpiece, or a removable mouthpiece.

The aerosol-generating article according to any of the aspects disclosed herein may have an air flow path extending through the aerosol-generating article. The aerosol-generating article may have an airflow path defined through the aerosol-generating article in an x/y plane from one side of the aerosol-generating article to the other side of the aerosol-generating article. The airflow path may be defined through the aerosol-generating article between a distal end and a proximal end of the aerosol-generating article. The airflow path may be defined through the aerosol-generating article from an air inlet, through the cavity, and to an air outlet. The airflow path may be defined through the airflow passage.

A resistance to draw (RTD) of the article, along the airflow path between the air inlet and the air outlet, may be less than 20 millimetre H₂O. The aerosol-generating article preferably has a resistance to draw (RTD) of less than 20 millimetre H₂O, for example less than 10 millimetre H₂O, in the direction of the airflow path. Preferably, the aerosol-generating article has a RTD of less than 20 millimetre H₂O, for example less than 10 millimetre H₂O, in at least one direction in an x/y plane of the aerosol-generating article. An aerosol-generating article with a low resistance airflow path may allow for superior air-flow management and allow aerosol to be extracted more efficiently from the aerosol-generating article and guided to a user.

Unless otherwise specified, the resistance to draw (RTD) is measured in accordance with ISO 6565-2015. The RTD refers to the pressure required to force air through the full length of a component, such as the aerosol-generating article. The terms “pressure drop” or “draw resistance” of a component or article may also refer to the “resistance to draw”. Such terms generally refer to the measurements made in accordance with ISO 6565-2015 and are normally carried out at under test at a volumetric flow rate of about 17.5 millilitres per second at the output or downstream end of the measured component at a temperature of about 22 degrees Celsius, a pressure of about 101 kPa (about 760 Torr) and a relative humidity of about 60 percent.

The aerosol-generating article according to any of the aspects disclosed herein may comprise substantially planar upper and lower surfaces. A vertical separation between the substantially planar upper and lower surfaces may define a height (for example, a z dimension) of the aerosol-generating article. An air flow passage may be defined between the substantially planar upper and lower surfaces. The height of the aerosol-generating article may be less than 5 millimetres, for example between 1.5 millimetres and 5 millimetres, for example between 1.5 millimetres and 4 millimetres, for example between 1.5 millimetres and 3 millimetres, for example between 1.5 millimetres and 2 millimetres. One or both of the substantially planar upper and lower surfaces may comprise an aerosol-forming substrate. The aerosol-generating article may comprise upper and lower layers, at least one of the upper and lower layers comprising or consisting of aerosol-forming substrate, the upper layer forming the substantially planar upper surface and the lower layer forming the substantially planar lower surface.

According to the present disclosure, there may be provided an aerosol-generating article comprising a first planar layer, a second planar layer, further comprising an intermediate layer arranged between the first planar layer and the second planar layer. A thickness of the aerosol-generating article may extend in a direction perpendicular to the first planar layer and the second planar layer, in which a cavity is defined between the first planar layer and the second planar layer. A height of the cavity may be defined by the distance between a lower surface of the first planar layer and an upper surface of the second planar layer. The thickness of the aerosol-generating article may be less than 5 millimetres. The height of the cavity may be greater than 50 percent of the thickness of the aerosol-generating article.

At least a portion of the intermediate layer may be arranged inside the cavity. Alternatively, or in addition, at least a portion of the intermediate layer may be arranged outside of the cavity, for example at least a portion of the intermediate layer may at least partially circumscribe the cavity.

The intermediate layer may be a corrugated layer arranged between the first planar layer and the second planar layer. At least one of the first planar layer, the second planar layer and the corrugated layer may comprise or consist of an aerosol-forming substrate.

The intermediate layer may be attached to the first layer by an adhesive. Alternatively, or in addition, the intermediate layer may be attached the second layer by an adhesive. The adhesive may comprise or consist of an aerosol-forming material.

A plurality of longitudinally extending passages may be defined by corrugations of a corrugated element located within the cavity. A porous element may be located in at least one of the longitudinally extending passages.

The longitudinally extending passages may extend in an x/y plane between a distal end and a proximal end of the aerosol-generating article.

The use of a corrugated structure in the aerosol-generating article may advantageously allow the production of an aerosol-generating article that has extremely low RTD while still being sufficiently rigid to for a user to handle. Further, use of a corrugated structure may allow a low density, low RTD, aerosol-generating article to be produced using high speed production methods similar to those used for production of corrugated cardboard.

According to the present disclosure, there may be provided an aerosol-generating article, the aerosol-generating article comprising: a first planar external surface, a second planar external surface, a cavity, a frame positioned between the first planar external surface and the second planar external surface, the frame at least partially defining the cavity, an aerosol-forming substrate positioned between the first planar external surface and the second planar external surface, and an air inlet and an air outlet, and an airflow passage extending between the air inlet and the air outlet through the cavity. The aerosol-generating article may comprise a first planar layer extending in a first plane and a second planar layer extending in a second plane, the second plane being parallel to and spaced from the first plane. A thickness of the aerosol-generating article may extend in a direction perpendicular to the first plane and the second plane, in which the cavity is defined between the first planar layer and the second planar layer. A height of the cavity may be defined by the distance between a lower surface of the first planar layer and an upper surface of the second planar layer. The thickness of the aerosol-generating article may be less than 5 millimetres. The height of the cavity may be greater than 50 percent of the thickness of the aerosol-generating article.

The first planar layer may comprise or form the first planar external surface. The second planar layer may comprise or form the second planar external surface. The first planar external surface may oppose the lower surface of the first planar layer. The second planar external surface may oppose the upper surface of the second planar layer.

The thickness of the of the aerosol-generating article may be defined between the first planar external surface and the second planar external surface.

The aerosol-generating article may comprise a planar frame positioned between the first planar layer and the second planar layer, preferably in which the cavity is defined by the lower surface of the first planar layer, the upper surface of the second planar layer, and internal walls of the planar frame.

Advantageously, the frame may allow the aerosol-generating article to be relatively thin whilst maintaining structural rigidity.

The frame may comprise a peripheral wall at least partially circumscribing or encircling the cavity. The frame may comprise a peripheral wall wholly circumscribing or encircling the cavity. Advantageously, the peripheral wall allows for a relatively large internal volume for an aerosol-generating material for aerosol formation whilst providing structural strength to maintain the shape of the aerosol-generating article.

Optionally, at least one of the first planar layer, the second planar layer, and the frame may comprise or consist of aerosol-forming substrate.

The cavity may be substantially empty.

Aerosol-forming substrate may be positioned within the cavity.

An intermediate layer such as a corrugated layer may be positioned within the cavity.

The aerosol-generating article of any of the aspects of the present disclosure may have a length (for example, an x dimension) of between 10 millimetres and 100 millimetres, or between 15 millimetres and 55 millimetres, or between 20 millimetres and 45 millimetres, for example between 25 mm and 35 mm, for example about 25 mm, or 28 mm, or 30 mm, or 32 mm. The aerosol-generating article of any of the aspects of the present disclosure may have a length (for example, an x dimension) of between 10 millimetres and 50 millimetres, for example between 12 millimetres and 30 millimetres, for example between 14 millimetres and 26 millimetres, for example between 16 millimetres and 24 millimetres, for example between 18 millimetres and 22 millimetres, for example about 18 millimetres, or about 19 millimetres, or about 20 millimetres, or about 21 millimetres, or about 22 millimetres.

The aerosol-generating article may have a width (for example, a y dimension) of between 5 millimetres and 20 millimetres, for example between 6 millimetres and 15 millimetres, for example between 7.5 millimetres and 13 millimetres, for example between 8 millimetres and 18 millimetres, for example between 9 millimetres and 12.5 millimetres or for example between 10 millimetres and 16 millimetres, for example between 11 millimetres and 15 millimetres, for example between 12 millimetres and 14 millimetres, for example about 9.5 millimetres, or 10 millimetres, or 11 millimetres, or 12 millimetres, or 13 millimetres.

The aerosol-generating article may have a thickness (for example, a z dimension) of between 0.5 millimetres and 5 millimetres for example between 1 millimetres and 4.75 millimetres, for example between 1.5 millimetres and 4.5 millimetres, for example between 2 millimetres and 4 millimetres, for example about 2.5 millimetres, or about 2.75 millimetres, or about 3 millimetres. The aerosol-generating article may have a thickness (for example, a z dimension) of between for example between 1.2 millimetres and 8 millimetres, for example between 1.4 millimetres and 7 millimetres, for example between 1.6 millimetres and 6 millimetres, for example between 1.7 millimetres and 5 millimetres, for example about 1.7 millimetres, or about 4.5 millimetres, or about 2 millimetres, or about 3 millimetres, or about 4 millimetres.

Advantageously, these thicknesses may provide a small temperature gradient or difference across the thickness of the aerosol-generating substrate during heating. Advantageously, this may allow heating of a greater proportion of the aerosol-generating substrate to a temperature at which an aerosol is released whilst minimising the risk of burning the hottest portion of the aerosol-generating substrate closest to the heater. Alternatively, or in addition, this may reduce time required to heat the aerosol-generating substrate sufficiently to release an aerosol.

The height of the cavity may between 0.25 millimetres and 4.9 millimetres, for example between 0.375 millimetres and 4.5 millimetres, for example between 0.5 millimetres and 4 millimetres, for example between 0.625 millimetres and 3.5 millimetres, for example about 2 millimetres, or about 2.5 millimetres, or about 2.9 millimetres.

The cavity may have a width of between 4.75 millimetres and 19.75 millimetres, for example between 5.75 millimetres and 14.75 millimetres, for example between 7.25 millimetres and 12.75 millimetres, for example between 8.75 millimetres and 12.25 millimetres, for example about 9.25 millimetres, or 9.5 millimetres, or 10.5 millimetres, or 11.5 millimetres.

The thickness of the first planar layer and/or the second planar layer may be between 150 microns and 1000 microns, for example between 250 microns and 800 microns, for example between 300 microns and 600 microns, for example between 350 microns and 500 microns, for example about 200 microns, or about 250 microns, or about 300 microns, or about 350 microns, or about 400 microns.

The aerosol-generating article of any of the aspects of the present disclosure when viewed in plan may have a shape defining a polygon, a quadrilateral (for example, a rectangle or a square), oval, or circle, or a combination thereof. Where the aerosol-generating article comprises substantially planar upper and lower surfaces, one or both of the upper and lower surfaces when viewed in plan may have a shape defining a polygon, a quadrilateral (for example, a rectangle or a square), an oval, a circle, or a combination thereof. A perimeter of the aerosol-generating article when viewed in plan may be formed of a plurality of straight sides, a plurality of curved sides, or a combination of straight and curved sides. Where the aerosol-generating article comprises substantially planar upper and lower surfaces, a perimeter of one or both of the upper and lower surfaces when viewed in plan may have a shape defining a polygon, a quadrilateral (for example, a rectangle or a square), an oval, a circle, or a combination thereof.

The aerosol-generating article may consist entirely of aerosol-forming substrate. Alternatively, the aerosol-forming substrate may be one of a plurality of component parts of the aerosol-generating article. The aerosol-forming substrate may comprise the aerosol-forming material.

The first planar layer may comprise the aerosol forming material. Alternatively, or in addition the second planar layer may comprise the aerosol forming material. For example, the first planar layer may comprise a sheet of homogenised tobacco. Alternatively, or in addition, the second planar layer may comprise a sheet of homogenised tobacco.

Advantageously, the aerosol-forming material may be heated quickly and efficiently by an external heater.

Preferably, the first planar layer comprises an aerosol-forming layer comprising aerosol-forming material and at least one further layer, for example an external layer, or a wrapper layer. Preferably, the second planar layer comprises an aerosol-forming layer comprising aerosol-forming material and at least one further layer, for example an external layer, or a wrapper layer. Optionally, both the first planar layer and the second planar layer comprise an aerosol-forming layer comprising aerosol-forming material and at least one further layer, for example an external layer, or a wrapper layer.

The aerosol-forming material may be located within the cavity.

The aerosol-forming substrate, in particular the aerosol-forming material, may comprise nicotine. Nicotine may be present in the form of a tobacco material or may be in the form of a nicotine extract.

Preferably, the aerosol-forming substrate, in particular the aerosol-forming material, comprises, or consists of, homogenised tobacco material, for example a reconstituted tobacco material or a cast leaf tobacco material.

The aerosol-forming substrate may comprise, or consist of, a solid aerosol-forming material. The aerosol-forming substrate may comprise a liquid aerosol-forming material, for example a liquid aerosol-forming material retained within a porous matrix. The aerosol-forming substrate may comprise a gel aerosol-forming material.

The aerosol-forming substrate may comprise one or more aerosol-formers. Suitable aerosol-formers are well known in the art and include, but are not limited to, one or more aerosol-formers selected from: polyhydric alcohols, such as propylene glycol, polyethylene glycol, triethylene glycol, 1, 3-butanediol and glycerine; esters of polyhydric alcohols, such as glycerol mono-, di-or triacetate; and aliphatic esters of mono-, di-or polycarboxylic acids, such as dimethyl dodecanedioate and dimethyl tetradecanedioate. It may be particularly preferable for the aerosol-former to be or comprise glycerine.

The aerosol-forming substrate may comprise at least 1, 2, 5, 10, or 15 weight percent aerosol-former. The aerosol-forming substrate may comprise greater than 15 weight percent aerosol-former, for example greater than 20 weight percent, or greater than 25 weight percent, or greater than 30 weight percent, or greater than 40 weight percent, or greater than 50 weight percent aerosol-former.

The aerosol-forming substrate may comprise less than or equal to 30 percent by weight of aerosol former, less than or equal to 25 percent by weight of aerosol former, or less than or equal to 20 percent by weight of aerosol former. That is, the aerosol-forming substrate may have an aerosol former content of less than or equal to 30 percent by weight, less than or equal to 25 percent by weight, or less than or equal to 20 percent by weight.

The aerosol-forming substrate may comprise between 1 percent and 30 percent by weight of aerosol former, between 1 percent and 25 percent by weight of aerosol former, or between 1 percent and 20 percent by weight of aerosol former.

The aerosol-forming substrate may comprise between 5 percent and 30 percent by weight of aerosol former, between 5 percent and 25 percent by weight of aerosol former, or between 5 percent and 20 percent by weight of aerosol former.

The aerosol-forming substrate may comprise between 10 percent and 30 percent by weight of aerosol former, between 10 percent and 25 percent by weight of aerosol former, or between 10 percent and 20 percent by weight of aerosol former.

The aerosol-forming substrate may comprise between 15 percent and 30 percent by weight of aerosol former, between 15 percent and 25 percent by weight of aerosol former, or between 15 percent and 20 percent by weight of aerosol former.

The aerosol-forming substrate may comprise at least 50 percent by weight of aerosol former, at least 60 percent by weight of aerosol former, or at least 70 percent by weight of aerosol former.

The aerosol-forming substrate may comprise less than or equal to 85 percent by weight of aerosol former, less than or equal to 80 percent by weight of aerosol former, or less than or equal to 75 percent by weight of aerosol former.

The aerosol-forming substrate may comprise between 50 percent and 85 percent by weight of aerosol former, between 50 percent and 80 percent by weight of aerosol former, or between 50 percent and 75 percent by weight of aerosol former.

The aerosol-forming substrate may comprise between 60 percent and 85 percent by weight of aerosol former, between 60 percent and 80 percent by weight of aerosol former, or between 60 percent and 75 percent by weight of aerosol former.

The aerosol-forming substrate may comprise between 70 percent and 85 percent by weight of aerosol former, between 70 percent and 80 percent by weight of aerosol former, or between 70 percent and 75 percent by weight of aerosol former.

The aerosol-forming substrate may comprise nicotine. The aerosol-forming material may comprise natural nicotine, or synthetic nicotine, or a combination of natural nicotine and synthetic nicotine.

The aerosol-forming substrate may comprise at least 0.5 percent by weight of nicotine, at least 1 percent by weight of nicotine, at least 1.5 percent by weight of nicotine, or at least 2 percent by weight of nicotine. That is, the aerosol-forming substrate may have a nicotine content of at least 0.5 percent by weight, at least 1 percent by weight, at least 1.5 percent by weight, or at least 2 percent by weight.

The aerosol-forming substrate may comprise one or more cannabinoid compounds such as one or more of: tetrahydrocannabinol (THC), tetrahydrocannabinolic acid (THCA), cannabidiol (CBD), cannabidiolic acid (CBDA), cannabinol (CBN), cannabigerol (CBG), cannabigerol monomethyl ether (CBGM), cannabivarin (CBV), cannabidivarin (CBDV), tetrahydrocannabivarin (THCV), cannabichromene (CBC), cannabicyclol (CBL), cannabichromevarin (CBCV), cannabigerovarin (CBGV), cannabielsoin (CBE), cannabicitran (CBT). It may be preferable that the cannabinoid compound is CBD or THC. It may be particularly preferable that the cannabinoid compound is CBD.

The aerosol-forming substrate may comprise one or more flavourants. The one or more flavourants may comprise one or more of: one or more essential oils such as eugenol, peppermint oil and spearmint oil; one or both of menthol and eugenol; one or both of anethole and linalool; and a herbaceous material. Suitable herbaceous material includes herb leaf or other herbaceous material from herbaceous plants including, but not limited to, mints, such as peppermint and spearmint, lemon balm, basil, cinnamon, lemon basil, chive, coriander, lavender, sage, tea, thyme, and caraway. The one or more flavourants may comprise a tobacco material.

The aerosol-forming substrate may have a moisture content of about 5 to 25 percent, preferably of about 7 to 15 percent, at final product state. For example, the aerosol-forming substrate may be a homogenised tobacco material with a moisture of about 5 to 25 percent, preferably of about 7 to 15 percent, at final product state.

The aerosol-forming substrate may comprise tobacco leaf; for example about 15 to 45 percent, preferably of about 20 to 35 percent of a blend of tobacco leaf, incorporating at least one of the following tobacco types: bright tobacco; dark tobacco; aromatic tobacco. Tobacco material such as tobacco leaf is preferably ground and graded to a particle size of about 100 to 380 mesh, preferably of about 170 to 320 mesh.

“Tobacco type” means one of the different varieties of tobacco, for example based on the distinct curing process that the tobacco undergoes before it is further processed in a tobacco product.

Examples of bright tobaccos are Flue-Cured Brazil, Indian Flue-Cured, Chinese Flue-Cured, US Flue-Cured such as Virginia tobacco, and Flue-Cured from Tanzania.

Examples of aromatic tobaccos are Oriental Turkey, Greek Oriental, semi-oriental tobacco but also Fire Cured, US Burley, such as Perique, and Rustica.

Examples of dark tobacco are Dark Cured Brazil Galpao, Burley Malawi or other African Burley, Sun Cured or Air Cured Indonesian Kasturi.

The aerosol-forming substrate may comprise Cellulose fibres. For example, the aerosol-forming substrate may comprise about 1 to 15 percent of cellulose fibres, preferably of about 3 to 7 percent of cellulose fibres. Preferably, cellulose fibres may have a length of about 10 to 250 μm, preferably of about 10 to 120 μm.

The aerosol-forming substrate may comprise organic fibres such as non-tobacco fibres, or tobacco fibres. For example, the aerosol-forming substrate may comprise about 5 to 20 percent, preferably about 7 to 15 percent of tobacco fibres. Tobacco fibres are preferably derived from stems and/or or stalks, graded to fibres of a length of about 10 to 350 μm, preferably of about 10 to 180 μm. The aerosol-forming substrate may comprise about 10 to 30 percent, preferably of about 15 to 25 percent, of a non-tobacco organic fibre. For example, organic fibres may derive from cellulose, cotton, wood, tea botanical varieties as sub-products, and sub-processed waste, the tea industry. Organic fibres are preferably of a length of about 10 to 400 μm, preferably of about 10 to 200 μm.

The aerosol-forming substrate may comprise a binder. For example, the aerosol-forming substrate may comprise about 1 to 10 percent, preferably of about 1 to 5 percent, of a binder such as any of common gums or pectins used in food and beverage (F&B) industries. Preferred binders may be natural pectins, such as fruit, for example citrus, or tobacco pectins; guar gums, land locust bean gums, such as hydroxyethyl and/or hydroxypropyl of those; starches, such as modified or derivatized starches; alginate; methyl, ethyl, ethylhydroxymethyl and carboxymethyl, celluloses; dextran; and xanthan gum. A preferable binder is guar.

The aerosol-forming substrate may comprise an organic botanical glycerite. For example, the aerosol-forming substrate may comprise about 15 to 55 percent, preferably of about 20 to 35 percent, of botanicals such as Clove, Echinacea sp., Fennel, Ginger, Hawthorn berry, Elderberry, Monarda, Mullein leaves, Nettle, Plantain, Turmeric, Yarrow, and compounds of those.

The aerosol-forming substrate may comprise organic botanical extracts. For example, the aerosol-forming substrate may comprise about 1 to 15 percent, preferably of about 2 to 7 percent, of any of the previously referred botanicals, as well as menthol (dl-Menthol, C10H20O, 2-Isopropyl-5-methylcyclohexanol) such as obtained from Chaerophyllum macrospermum, Mesosphaerum sidifolium, or other related botanic varieties, as well as P-menthan-3-ol, as any secondary alcohol as diastereoisomers of 5-methyl-2-(propan-2-yl)cyclohexan-1-ol.

The aerosol-forming substrate may comprise botanical essential oils, for example about 0.5 to 5 percent, preferably of about 1 to 3 percent, of a botanical essential oil, for example a botanical essential oil such as of palm, coconut, and wooden-based essential oils.

The aerosol-forming substrate preferably comprises an aerosol-former, for example about 5 to 35 percent, preferably of about 10 to 25 percent, of an aerosol former. Suitable aerosol-formers known in the art include: glycerine; monohydric alcohols like menthol, polyhydric alcohols, such as triethylene glycol; esters of polyhydric alcohols, such as glycerol mono-, di-or triacetate; and aliphatic esters of mono-, di-or polycarboxylic acids, such as dimethyls of those.

As used herein, the term “aerosol-generating article” may refer to an article able to generate, or release, an aerosol.

As used herein, the term “aerosol-forming substrate” may refer to a substrate capable of releasing an aerosol or volatile compounds that can form an aerosol. Such volatile compounds may be released by heating the aerosol-forming substrate. An aerosol-forming substrate may comprise an aerosol-forming material. An aerosol-forming substrate may be adsorbed, coated, impregnated, or otherwise loaded onto a carrier or support. An aerosol-forming substrate may conveniently be part of an aerosol-generating article or smoking article.

As used herein, the term “aerosol-generating device” may refer to a device for use with an aerosol-generating article to enable the generation, or release, of an aerosol.

As used herein, the term “aerosol generating system” refers to a combination of an aerosol-generating device and one or more aerosol-forming articles for use with the device. An aerosol-generating system may include additional components, such as a charging unit for recharging an on-board electric power supply in an electrically operated or electric aerosol-generating device.

As used herein, the term “aerosol former” may refer to any suitable known compound or mixture of compounds that, in use, facilitates formation of an aerosol. The aerosol may be a dense and stable aerosol. The aerosol may be substantially resistant to thermal degradation at the operating temperature of the aerosol-forming substrate or aerosol-generating article.

As used herein with reference to the invention, the term “nicotine”, is used to describe nicotine, nicotine base or a nicotine salt.

As used herein with reference to the invention, the terms “proximal”, “distal”, “upstream” and “downstream” are used to describe the relative positions of components, or portions of components, of the aerosol-generating article.

As used herein, the term “longitudinal” refers to the direction corresponding to the main longitudinal axis of the aerosol-generating article, which extends between the upstream and downstream ends of the aerosol-generating article. During use, air may be drawn through the aerosol-generating article in the longitudinal direction.

As used herein, the term “sheet” denotes a laminar element having a width and length substantially greater than the thickness thereof. The width of a sheet may be greater than 10 millimetres, preferably greater than 20 millimetres or 30 millimetres. In certain embodiments, sheets of material for use in forming aerosol-forming substrates as described herein may have a thickness of between 10 microns and about 1000 microns, for example between 10 microns and about 300 microns.

As used herein, the term “homogenised tobacco material” encompasses any tobacco material formed by the agglomeration of particles of tobacco material. Sheets or webs of homogenised tobacco material are formed by agglomerating particulate tobacco obtained by grinding or otherwise powdering of one or both of tobacco leaf lamina and tobacco leaf stems. In addition, homogenised tobacco material may comprise a minor quantity of one or more of tobacco dust, tobacco fines, and other particulate tobacco by-products formed during the treating, handling and shipping of tobacco. The sheets of homogenised tobacco material may be produced by casting, extrusion, paper making processes or other any other suitable processes known in the art.

The term “cast leaf” is used herein to refer to a product made by a casting process that is based on casting a slurry comprising plant particles (for example, clove particles or tobacco particles and clove particles in a mixture) and a binder (for example, guar gum) onto a supportive surface, such as a belt conveyor, drying the slurry and removing the dried sheet from the supportive surface. An example of the casting or cast leaf process is described in, for example, U.S. Pat. No. 5,724,998 for making cast leaf tobacco. In a cast leaf process, particulate plant materials are produced by pulverizing, grinding, or comminuting parts of the plant. The particles produced from one or more plants are mixed with a liquid component, typically water, to form a slurry. Other components in the slurry may include fibres, a binder and an aerosol former. The particulate plant materials may be agglomerated in the presence of the binder. The slurry is cast onto a supportive surface and dried into a sheet of homogenized plant material. Preferably, homogenized plant material used in articles according to the present invention may be produced by casting. Such homogenized plant material may comprise agglomerated particulate plant material.

As used herein, resistance to draw is expressed with the units of pressure “mm H₂O” or “mm WG” or “mm of water gauge” and may be measured in accordance with ISO 6565: 2002.

The invention is defined in the claims. However, below there is provided a non-exhaustive list of non-limiting examples. Any one or more of the features of these examples may be combined with any one or more features of another example, embodiment, or aspect described herein.
Ex1. An aerosol-generating article comprising an aerosol-forming material for producing an aerosol, the aerosol-forming article comprising a first planar layer extending in a first plane and a second planar layer extending in a second plane, the second plane being parallel to and spaced from the first plane, a thickness of the article extending in a direction perpendicular to the first plane and the second plane, in which a cavity is defined between the first planar layer and the second planar layer, a height of the cavity being defined by the distance between a lower surface of the first planar layer and an upper surface of the second planar layer, and in which the thickness of the aerosol-generating article is less than 5 mm and the height of the cavity is greater than 50 percent of the thickness of the article.
Ex2. An aerosol-generating article according to example Ex1 in which a thickness of the aerosol-generating article is defined by the distance between an upper surface of the aerosol-generating article and a lower surface of the aerosol-generating article, for example between an upper surface of the first planar layer and a lower surface of the second planar layer.
Ex3. An aerosol-generating article according to Ex1 or Ex2 in which the thickness of the aerosol-generating article is defined by the distance between an upper surface of the first planar layer and a lower surface of the second planar layer.
Ex4. An aerosol-generating article according to any preceding example in which the aerosol-generating article is defined by an article length extending in an x direction, an article width extending in a y direction, and an article thickness extending in a z direction, in which an air flow passage is defined through the aerosol-forming article between an air flow inlet and an air flow outlet, the air flow passage flowing through the cavity.
Ex5. An aerosol-generating article according to Ex4 in which the air flow inlet is defined by an inlet width and an inlet height, in which the inlet width is greater than 80 percent of the article width, and the inlet height is greater than 25 percent of the article height, optionally in which the air flow inlet is substantially rectangular.
Ex6. An aerosol-generating article according to any preceding example in which the height of the cavity is greater than 60 percent of the thickness of the article, for example greater than 70 percent of the thickness of the article, for example greater than 80 percent of the thickness of the article, preferably greater than 85 percent of the thickness of the article, or greater than 90 percent of the thickness of the article, for example greater than 95 percent of the thickness of the article.
Ex7. An aerosol-generating article according to any preceding example in which the thickness of the article is between 0.5 mm and 5 mm, for example between 1 mm and 4.75 mm, for example between 1.5 mm and 4.5 mm, for example between 2 mm and 4 mm, for example about 2.5 mm, or about 2.75 mm, or about 3 mm.
Ex8. An aerosol-generating article according to any preceding example in which the height of the cavity is between 0.25 mm and 4.9 mm, for example between 0.375 mm and 4.5 mm, for example between 0.5 mm and 4 mm, for example between 0.625 mm and 3.5 mm, for example about 2 mm, or about 2.5 mm, or about 2.9 mm.
Ex9. An aerosol-generating article according to any preceding example in which the first planar layer and/or the second planar layer comprise the aerosol forming material, for example in which the first planar layer and/or the second planar layer comprise a sheet of homogenised tobacco.
Ex10. An aerosol-generating article according to any preceding example in which the first planar layer and/or the second planar layer comprises an aerosol-forming layer comprising aerosol-forming material and at least one further layer, for example an external layer, or a wrapper layer.
Ex11. An aerosol-generating article according to any preceding example in which the thickness of the first layer and/or the second layer is between 150 micron and 1000 micron, for example between 250 micron and 800 micron, for example between 300 micron and 600 micron, for example between 350 micron and 500 micron, for example about 200 micron, or about 250 micron, or about 300 micron, or about 350 micron, or about 400 micron.
Ex12. An aerosol-generating article according to any preceding example in which the article has a width of between 5 mm and 20 mm, for example between 6 mm and 15 mm, for example between 7.5 mm and 13 mm, for example between 9 mm and 12.5 mm, for example about 9.5 mm, or 10 mm, or 11 mm, or 12 mm.
Ex13. An aerosol-generating article according to Ex12 in which the cavity has a width of between 4.75 mm and 19.75 mm, for example between 5.75 mm and 14.75 mm, for example between 7.25 mm and 12.75 mm, for example between 8.75 mm and 12.25 mm, for example about 9.25 mm, or 9.5 mm, or 10.5 mm, or 11.5 mm.
Ex14. An aerosol-generating article according to any preceding example in which the article has a length of between 10 mm and 100 mm, for example between 15 mm and 55 mm, for example between 20 mm and 45 mm, for example between 25 mm and 35 mm, for example about 25 mm, or 28 mm, or 30 mm, or 32 mm.
Ex15. An aerosol-generating article according to any preceding example in which an air flow inlet is defined at a distal end of the article, the air flow inlet configured to allow air to flow into the cavity.
Ex16. An aerosol-generating article according to any preceding example in which the article further defines a mouthpiece in fluid communication with the cavity, for example an integral mouthpiece, or a removable mouthpiece.
Ex17. An aerosol-generating article according to any preceding example in which an airflow path is defined through the aerosol-generating article from an air inlet, through the cavity, and to an air outlet, in which a resistance to draw (RTD) of the article, along the airflow path between the air inlet and the air outlet, is less than 20 millimetre H₂O.
Ex18. An aerosol-generating article according to any preceding example in which an aerosol-forming material is located within the cavity.
Ex19. An aerosol-generating article according to any preceding example, wherein an air-flow path is defined through the aerosol-generating article between a distal end and a proximal end of the aerosol-generating article.
Ex20. An aerosol-generating article according to any preceding example, further comprising an intermediate layer arranged between the first planar layer and the second planar layer.
Ex21. An aerosol-generating article according to any preceding example, wherein a plurality of longitudinally extending passages are defined by corrugations of a corrugated element located within the cavity.
Ex22. An aerosol-generating article according to Ex21, wherein the longitudinally extending passages extend in an x/y plane between a distal end and a proximal end of the article.
Ex23. An aerosol-generating article according to any preceding example, further comprising a planar frame positioned between the first planar layer and the second planar layer, preferably in which the cavity is defined by a lower surface of the first layer, an upper surface of the second layer, and internal walls of the planar frame.

Examples will now be further described with reference to the figures in which:

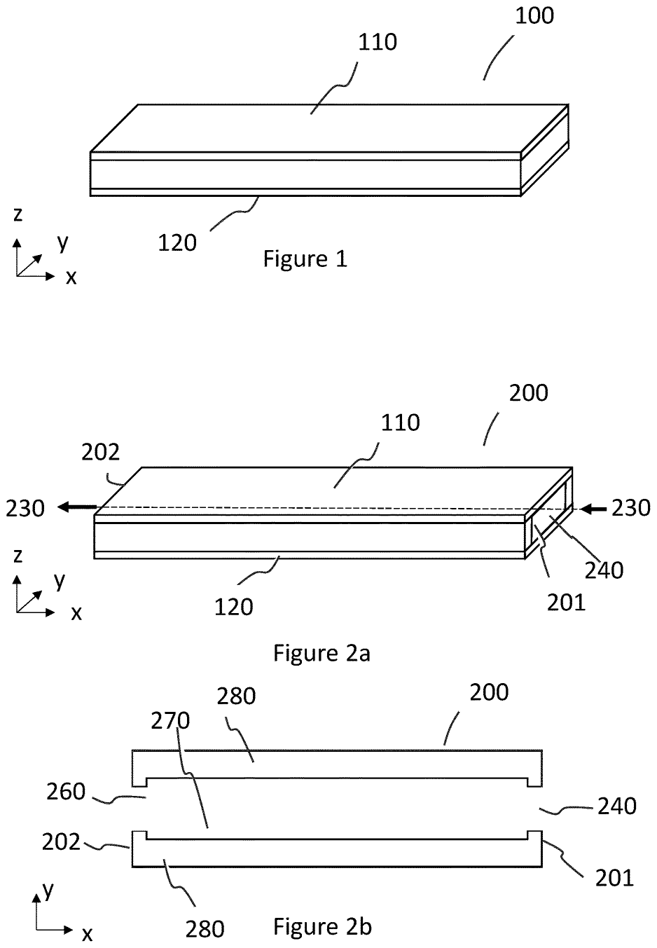

FIG. 1 is a perspective side view of an aerosol-generating article according to a first embodiment of the present disclosure;

FIG. 2a is a perspective side view of an aerosol-generating article according to a second embodiment of the present disclosure;

FIG. 2b is a schematic lateral cross-sectional view of the aerosol-generating article of FIG. 2a;

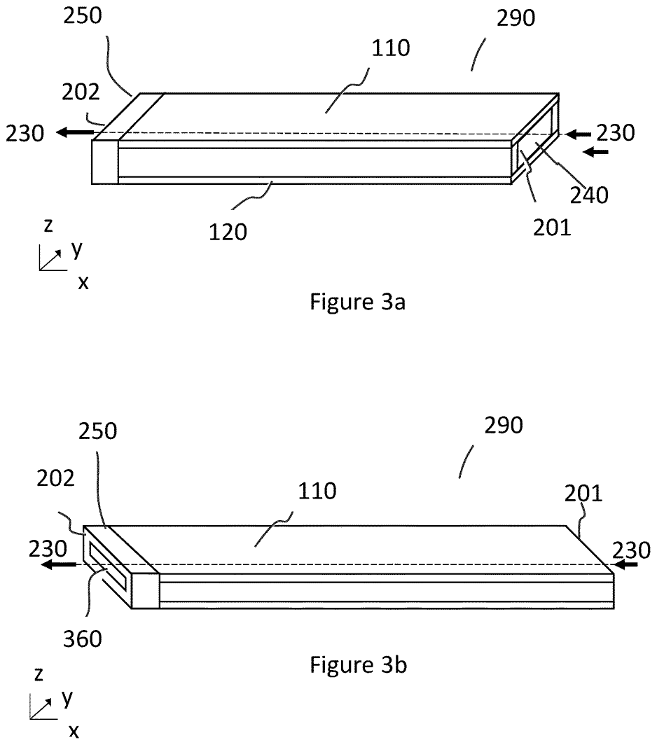

FIG. 3a is a perspective side view of an aerosol-generating article according to a third embodiment of the present disclosure;

FIG. 3b is an alternative perspective side view of the aerosol-generating article according to the third embodiment of the present disclosure;

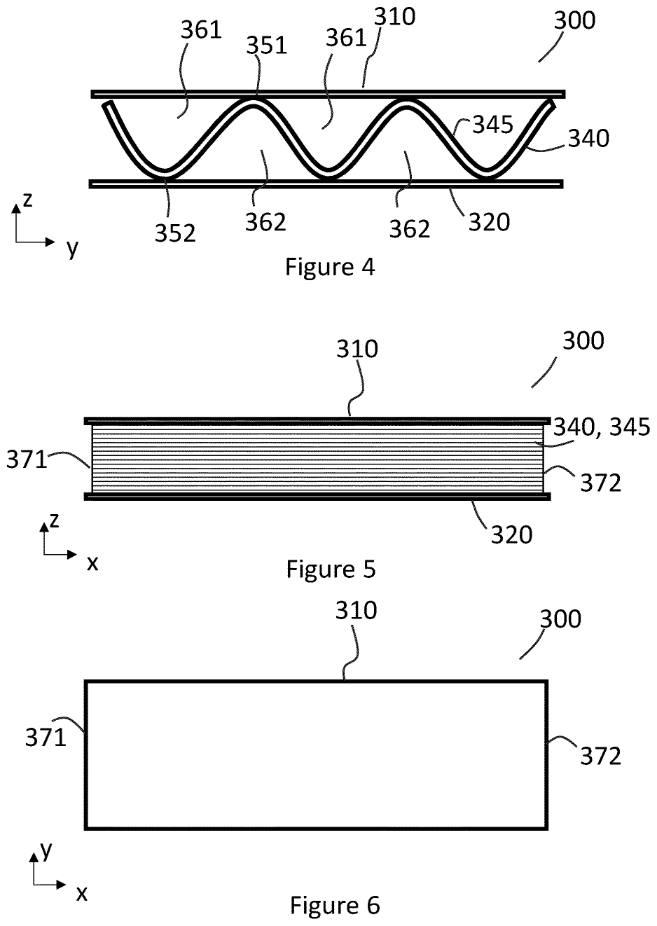

FIG. 4 is a schematic end view of an aerosol-generating article according to a fourth embodiment of the present disclosure;

FIG. 5 is a schematic side view of the aerosol-generating article of FIG. 4;

FIG. 6 is a schematic plan view of the aerosol-generating article of FIG. 4;

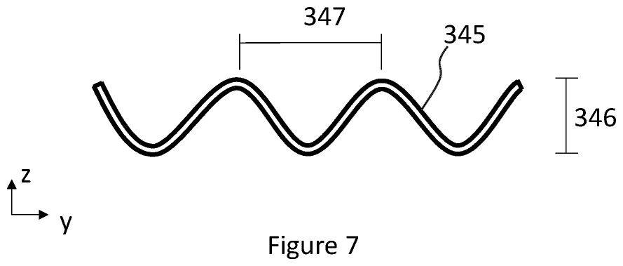

FIG. 7 shows a schematic illustration of a corrugated element as used in the aerosol-generating article of FIG. 4;

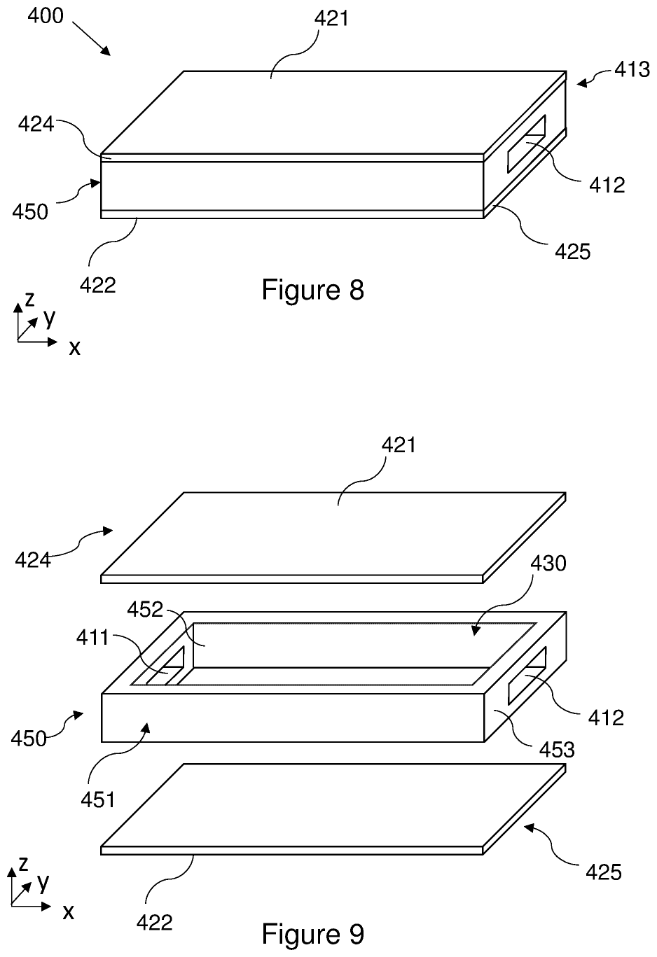

FIG. 8 shows a perspective view of an aerosol-generating article according to a fifth embodiment of the present disclosure;

FIG. 9 shows an exploded perspective view of the aerosol-generating article of FIG. 8;

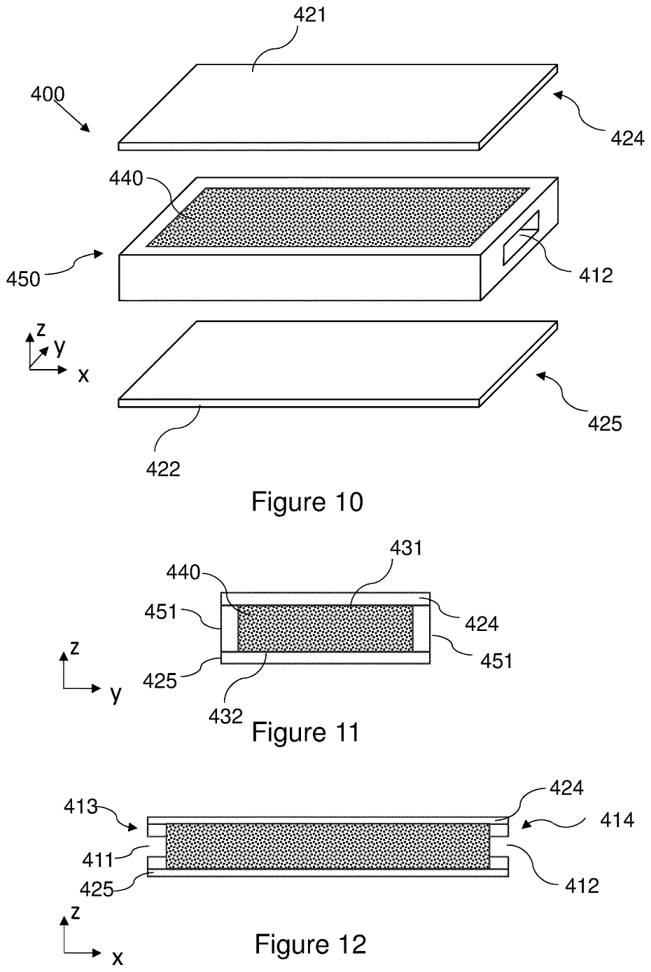

FIG. 10 shows a further exploded perspective view of the aerosol-generating article of FIG. 8;

FIG. 11 shows a schematic transverse cross-sectional view of the aerosol-generating article of FIG. 8;

FIG. 12 shows a schematic longitudinal cross-sectional view of the aerosol-generating article of FIG. 8;

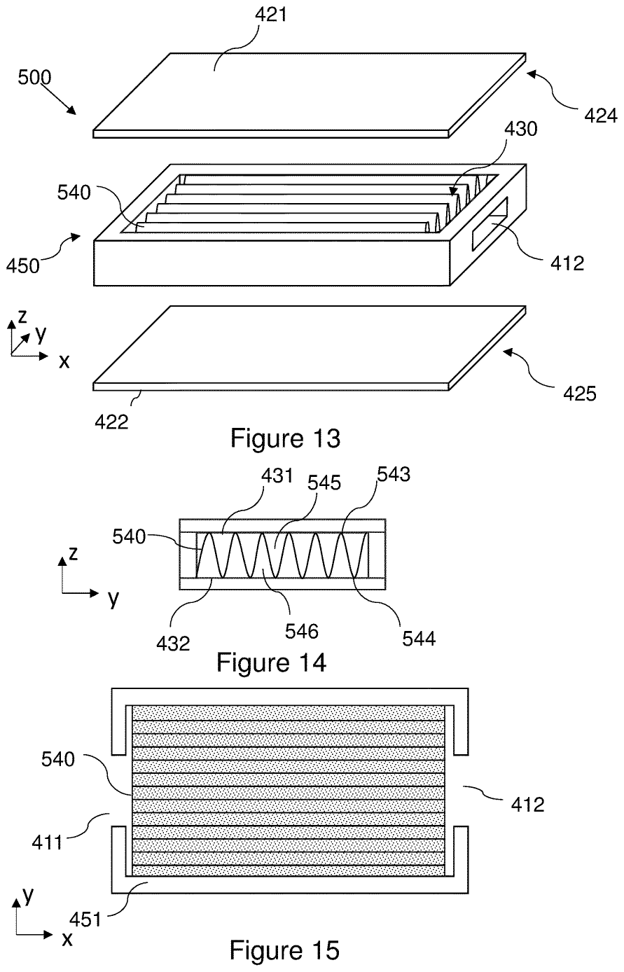

FIG. 13 shows an exploded perspective view of an aerosol-generating article according to a sixth embodiment of the present disclosure;

FIG. 14 shows a schematic transverse cross-sectional view of the aerosol-generating article of FIG. 13;

FIG. 15 shows a schematic lateral cross-sectional view of the aerosol-generating article of FIG. 13.

FIG. 1 illustrates a perspective side view of an aerosol-generating article 100 according to a first embodiment of the present disclosure. The aerosol-generating article 100 a first planar layer 110 extending in a first plane and a second planar layer 120 extending in a second plane, the second plane being parallel to and spaced from the first plane. A thickness of the aerosol-generating article 100 extends in a z dimension in a direction perpendicular to the first plane and the second plane. The aerosol-generating article 100 comprises an aerosol-forming substrate. In one embodiment, the aerosol-generating article 100 may consist substantially of aerosol-forming substrate. In another embodiment, the aerosol-forming substrate may be one of a plurality of component parts of the aerosol-generating article 100. The aerosol-forming substrate may be enclosed within an interior of the aerosol-generating article 100. The aerosol-forming substrate may at least partially define an exterior of the aerosol-generating article 100; for example, one or both of the first and second planar layers 110, 120 may comprise or consist of aerosol-forming substrate.

A suitable aerosol-forming substrate may be homogenised tobacco.

The aerosol-generating article 100 has a length, extending in an x dimension, of 80 millimetres, a width, extending in a y dimension, of 15 millimetres, and a height (which may also be referred to as the thickness), extending in a z dimension, of 3.6 millimetres. The thickness of the aerosol-generating article is defined by the distance between an upper surface of the aerosol-generating article, in this example that is an upper surface of the first planar layer 110, and a lower surface of the aerosol-generating article, in this example that is a lower surface of the second planar layer 120.

The aerosol-generating article 100 comprises a cavity (not shown in FIG. 1). The cavity is defined between the first planar layer 110 and the second planar layer 120. A height of the cavity is defined by the distance between a lower surface of the first planar layer 110 and an upper surface of the second planar layer 120. The height of the cavity is greater than 50 percent of the thickness of the article. The height of the cavity is greater than 1.8 millimetres, for example about 2.5 millimetres. The width of the cavity is about 12 mm.

The aerosol-forming article comprises an aerosol-forming material. In this embodiment, the first planar layer 110 and the second planar layer 120 each comprise a sheet of homogenised tobacco and an external layer. The external layer of the first planar layer 110 forms the upper surface of the first planar layer 110 and the external layer of the second planar layer 120 forms the lower surface of the second planar layer 120. Each external layer comprises a sheet of paper.

FIG. 2a illustrate a perspective side view of an aerosol-generating article 200 according to a second embodiment of the present disclosure, being a variant of aerosol-generating article 100. Features in common with aerosol-generating article 100 are referred to with like reference signs. An air flow path 230 is defined through the aerosol-generating article 200 between the upper and lower planar layers 110, 120. The air flow path 230 extends between opposed first and second ends 201, 202 of the aerosol-generating article 200. The first end 201 may define a distal end of the aerosol-generating article 200, and the second end 202 may define a proximal end of the aerosol-generating article. The air flow path 230 may be directed towards a mouth of a user to allow a user to inhale aerosol generated in consequence of heating of aerosol-forming substrate of the aerosol-generating article 200.

An air flow passage is defined through the aerosol-forming article 200 between an air flow inlet 240 and an air flow outlet (not shown in FIG. 2). The air flow passage extends through the cavity and is configured to allow, in use, air to flow from the air inlet 240, through the cavity and out of the air outlet 260. The air flow inlet 240 is defined by an inlet width and an inlet height, in which the inlet width is greater than 80 percent of the aerosol-generating article 200 width, and the inlet height is greater than 25 percent of the aerosol-generating article 200 height.

The airflow path is defined through the aerosol-generating article 200 from the air inlet 240, through the cavity, and to the air outlet, in which a resistance to draw (RTD) of the aerosol-generating article 200, along the airflow path between the air inlet 240 and the air outlet 260, is less than 20 millimetres H₂O.

FIG. 2b illustrates a schematic lateral cross-sectional view of the aerosol-generating article of FIG. 2a. FIG. 2b shows an internal cross-section of the aerosol-generating article. In use, when a user puffs on the air outlet 260, air is drawn into the aerosol-generating article through the air flow inlet 240, and along the air flow passage. The air flows through the cavity 270 to the air flow outlet 260.

Aerosol-forming material 280 is positioned on either side of the cavity 270. In addition, aerosol-forming material may be located within the cavity 270. In use, as the aerosol-generating article is heated by an external heater, the aerosol-forming material 280 in the aerosol-generating article 200 is heated and the aerosol-formers are vaporised. The vapours are entrained in air flow in the airflow passage as the user puffs on the air outlet 260. The vapours cool in the air flow and condense to form an aerosol, the aerosol may then be inhaled by the user.

FIG. 3a illustrates a perspective side view of an aerosol-generating article 290 according to a third embodiment of the present disclosure, being a variant of aerosol-generating articles 100, 200. FIG. 3b illustrates an alternative perspective side view of the aerosol-generating article 290. Features in common with aerosol-generating articles 100 and 200 are referred to with like reference signs.

The aerosol-generating article 290 comprises a mouthpiece 250. The mouthpiece 250 is in fluid communication with the cavity. As shown in FIG. 3b, the mouthpiece 250 comprises the air outlet 360. The mouthpiece 250 in this embodiment is integral. However, in other examples, the mouthpiece may be removable.

FIGS. 4, 5, and 6 illustrate respectively an end view, a side view, and a plan view of an aerosol-generating article 300 according to a fourth embodiment of the present disclosure. The aerosol-generating article 300 comprises a first planar layer, upper layer 310, which extends in a first plane, and a second planar layer, lower layer 320, which extends in a second plane that is parallel to and spaced from the first plane. The aerosol-generating article 300 further comprises an intermediate or separation layer 340 arranged between the upper layer 310 and lower layer 320. A thickness of the article 300 extends in a z direction perpendicular to the first plane and the second plane.

The planar upper layer 310 is formed from a sheet of paper having a thickness of 300 microns. The planar lower layer 320 is formed from a sheet of paper having a thickness of 300 microns. A cavity is defined between the upper layer 310 and the lower layer 320, a height of the cavity is defined by the distance between a lower surface of the upper layer 310 and an upper surface of the lower layer 320,

The intermediate layer 340 is located within the cavity. The intermediate layer 340 is a corrugated element formed from a corrugated sheet of aerosol-forming material 345. A suitable aerosol-forming material may be homogenised tobacco. Thus, the intermediate layer 340 may be formed from a corrugated sheet of homogenised tobacco material 345.

FIG. 7 illustrates the corrugated sheet of aerosol-forming material 345. The corrugations have an amplitude 346 of 3 millimetres and a wavelength 347 of 3 millimetres. The sheet of aerosol-forming material 345 forming the intermediate layer 340 has a thickness of 150 microns. Points of intersection 351, 352 between the upper layer 310 and the intermediate layer 340 and between the lower layer 320 and the intermediate layer 340 comprise an adhesive that joins the respective layers.

The aerosol-generating article 300 has a length, extending in an x dimension, of 80 millimetres, a width, extending in a y dimension, of 15 millimetres, and a thickness, extending in a z dimension, of 3.6 millimetres. The height of the cavity is greater than 50 percent of the thickness of the aerosol-generating article 300.

Corrugations of the intermediate layer 340 form a first set of longitudinally extending channels 361 that are bounded by the upper layer 310 and the intermediate layer 340, and a second set of longitudinally extending channels 362 bounded by the lower layer 320 and the intermediate layer 340. The first and second sets of longitudinally extending channels 361, 362 extend through the length of the intermediate layer 340 between a proximal end 371 of the aerosol-generating article 300 and a distal end 372 of the aerosol-generating article 300. The longitudinally extending channels 361, 362 extend in an x/y plane between the distal end 372 and a proximal end 371 of the aerosol-generating article 300.

The longitudinally extending channels 361, 362 define air flow channels through the aerosol-forming article between air flow inlets and air flow outlets. The air flow channels extend through the cavity, so that, in use, air flows through the cavity. The longitudinally extending channels 361, 362 define an air flow path through the aerosol-forming material 345. The air flow path, therefore, passes over both sides of the sheet of aerosol-forming material 345. The porosity of the aerosol-generating article along the air flow path is in the region of 90 percent. This provides a very low resistance to draw (RTD) of less than 5 millimetres H₂O. In fact, the RTD is close to zero.

The aerosol-forming material 345 may be a sheet of any suitable aerosol-forming material.

During use of the aerosol-generating article 300, the aerosol-forming material 345 is heated up to cause the aerosol-forming material 345 to release volatile compounds, which are then entrained in air drawn into the channels 361, 362 via the distal end 372. The volatile compounds then cool and condense to form an aerosol which may be drawn out of the channels 361, 362 of the aerosol-generating article 300 via the proximal end 371.

FIG. 8 shows an aerosol-generating article 400 according to a fifth embodiment of the present disclosure. The aerosol-generating article 400 comprises a first planar external layer 424 forming an upper planar external surface 421, a second planar external layer 425 forming a lower planar external surface 422, and a frame 450 positioned between the first planar external layer 424 and the second planar external layer 425. The lower planar external surface 422 is positioned parallel to the lower planar external surface 421. The thickness of the aerosol-generating article is defined by the upper surface 421 of the first planar external layer 424 and the lower surface 422 of the second planar external layer 425.

FIGS. 9 and 10 show exploded views of the aerosol-generating article 400 of FIG. 8. The frame 450 circumscribes and at least partially defines a cavity 430. FIG. 9 shows the cavity 430 in an empty state. FIG. 10 shows the cavity 430 filled with aerosol-forming substrate 440. FIGS. 11 and 12 show respective transverse and longitudinal cross-sectional views of the aerosol-generating article 400 when the cavity 430 is filled with aerosol-forming substrate 440.

The first planar external layer 424 and the second planar external layer 425 are made from cigarette paper having a thickness of 35 micrometres and are in physical contact, with and bonded to, the frame 450. The first planar external layer 424 overlies a first end of the cavity 430 and forms a first cavity end wall 431. The second planar external layer 425 overlies a second end of the cavity 430 and forms a second cavity end wall 432, the second cavity end wall 432 being opposite to the first cavity end wall 431. That is, the frame 450, the first planar external layer 424 and the second planar external layer 425 collectively define the cavity 430.

The frame 450 has a hollow cuboid shape and is made from cardboard. The frame 450 defines an aperture extending through the height (also referred to as the thickness) of the frame 450 and the aperture at least partially forms the cavity 430 of the aerosol-generating article 400. The frame 450 comprises a peripheral wall 451 that circumscribes the cavity 430. The peripheral wall 451 includes a front wall 413 and a back wall 414. In more detail, the peripheral wall 451 is defined by an inner transverse surface 452 of the frame 450 and an outer transverse surface 453 of the frame 450. The inner transverse surface 452 of the peripheral wall 451 at least partially defines a perimeter of the cavity 430. The outer transverse surface 453 of the peripheral wall 451 at least partially defines a perimeter of the aerosol-generating article 400. The peripheral wall 451 has a radial thickness measured between the inner transverse surface 452 of the frame 450 and the outer transverse surface 453 of the frame 450 of about 5 millimetres.

An air inlet 411 and an air outlet 412 are defined by, and extend through, the peripheral wall 451 of the frame 450. More specifically, the air inlet 411 extends through the front wall 413 and the air outlet 412 extends through the back wall 414. An airflow passage extends between the air inlet 411 and the air outlet 412 through the cavity 430. The air flow inlet 411 is configured to allow air to flow into the cavity and the air flow outlet 412 is configured to allow air to flow out of the cavity. As shown in FIGS. 10 to 12, an aerosol-forming substrate 440 is positioned within the cavity 430. The aerosol-forming substrate 440 comprises an aerosol-generating material in the form of tobacco cut filler and has an aerosol-former content of 5 percent by weight on a dry weight basis. As shown, the aerosol-forming substrate 440 fills the entire volume of the cavity 430.

The aerosol-generating article 400 has a cuboid shape and has a height (or thickness) extending in a z dimension, as measured between the first planar external surface 421 and the second planar external surface 422, of 4 millimetres, a width extending in a y dimension of 10 millimetres and a length extending in an x dimension of 60 millimetres. The frame 450 has a height (or thickness) extending in a z dimension of 3.93 millimetres, a width extending in a y dimension of 10 millimetres and a length extending in an x dimension of 60 millimetres. The cavity 430 has a height (or thickness) extending in a z dimension that is greater than 50 percent of the thickness of the aerosol-generating article 400. In this example, the cavity have a thickness of 3.93 millimetres, a width extending in a y dimension of 9.93 millimetres and a length extending in an x dimension of 52 millimetres.

The air inlet 411 is defined by an inlet width and an inlet height, in which the inlet width is greater than 80 percent of the aerosol-generating article width, and the inlet height is greater than 25 percent of the aerosol-generating article height. In this example, the air flow inlet is substantially rectangular and has an inlet width of 9 millimetres and an inlet height of 1.2 millimetres. FIG. 13 shows an aerosol-generating article 500 according to a sixth embodiment of the present disclosure. Features in common with aerosol-generating article 400 are referred to with like reference signs. Aerosol-generating article 500 differs from aerosol-generating article 400 in that the aerosol-forming substrate is in the form of a sheet of aerosol-generating material 540, in particular a corrugated sheet of homogenised tobacco material. FIGS. 14 and 15 show respective transverse and lateral cross-section views of the aerosol-generating article 500 of FIG. 13.

The corrugated sheet of homogenised tobacco material 540 comprises a plurality of parallel corrugations having a plurality of substantially parallel peaks 543 and troughs 544. The plurality of parallel corrugations are defined by a corrugation profile which, as seen in FIG. 13, is sinusoidal. The plurality of parallel corrugations have a corrugation wavelength of about 4.6 millimetres. The corrugation amplitude is approximately the same as the height (or thickness) of the cavity 430, as shown by the peaks 543 and troughs 544 coinciding with the first cavity end wall 431 and the second cavity end wall 432, respectively.

The plurality of parallel corrugations form a plurality of channels 545 between the sheet of aerosol-generating material 540 and the first cavity end wall 431, and a plurality of channels 546 between the sheet of aerosol-generating material 540 and the second cavity end wall 432. The plurality of channels 545, 546 extend in a longitudinal direction of the aerosol-generating article 500 and form at least a portion of the airflow passage extending between the air inlet 411 and the air outlet 412.

During use of each of the aerosol-generating articles 400, 500, the aerosol-forming substrate 440, 540 is heated up to cause the aerosol-forming substrate 440, 540 to release volatile compounds, which are then entrained in air drawn through the air inlet 411 into the cavity 430. The volatile compounds then cool and condense to form an aerosol which may be drawn out of the aerosol-generating article 400, 500 through the air outlet 412.

For exemplary purposes applicable to any of the embodiments described above, a composition of a suitable aerosol-forming substrate may be as follows. Percentages are given in weight percent with respect to the product in its final state. The aerosol-forming substrate may have a moisture of about 5 to 25 percent, preferably of about 7 to 15 percent, at final product state. The aerosol-forming substrate may further comprise the following:
1. Tobacco leaf; for example about 15 to 45 percent, preferably of about 20 to 35 percent of a blend of tobacco leaf, incorporating at least one of the following tobacco types: bright tobacco; dark tobacco; aromatic tobacco. Tobacco material is ground and graded to a particle size of about 100 to 380 mesh, preferably of about 170 to 320 mesh.
2. Cellulose fibres; for example about 1 to 15 percent, preferably of about 3 to 7 percent, of cellulose fibres, of a length of about 10 to 250 μm, preferably of about 10 to 120 μm.
3. Tobacco fibres; for example about 5 to 20 percent, preferably of about 7 to 15 percent of tobacco fibres, as filler, of any tobacco type or a blend of tobacco types. Tobacco fibres are preferably derived from stems and/or or stalks, graded to fibres of a length of about 10 to 350 μm, preferably of about 10 to 180 μm.
4. Binder; for example about 1 to 10 percent, preferably of about 1 to 5 percent, of a binder such as any of common gums or pectins used in food and beverage (F&B) industries. Preferred binders may be natural pectins, such as fruit, for example citrus, or tobacco pectins; guar gums, land locust bean gums, such as hydroxyethyl and/or hydroxypropyl of those; starches, such as modified or derivatized starches; alginate; methyl, ethyl, ethylhydroxymethyl and carboxymethyl, celluloses; dextran; and xanthan gum. The preferable binder is guar.
5. Aerosol-former; for example about 5 to 35 percent, preferably of about 10 to 25 percent, of an aerosol former. Suitable aerosol-formers known in the art include: glycerine; monohydric alcohols like menthol, polyhydric alcohols, such as triethylene glycol; esters of polyhydric alcohols, such as glycerol mono-, di-or triacetate; and aliphatic esters of mono-, di-or polycarboxylic acids, such as dimethyls of those. “Tobacco type” means one of the different varieties of tobacco, for example based on the distinct curing process that the tobacco undergoes before it is further processed in a tobacco product.

For exemplary purposes, a composition of a further aerosol-forming substrate, which may also be suitable for use as the aerosol-forming substrate in any of the embodiments described above is described below. Percentages are given in weight percent with respect to the product in its final state. The aerosol-forming substrate may comprise:
1. An aerosol-former such as Glycerin; for example about 10 to 40 percent, preferably of about 20 to 30 percent.
2. Organic fibres; for example about 10 to 30 percent, preferably of about 15 to 25 percent, of any botanical variety suitable and with purity to comply with applicable FDA F&B grade requirements, as commonly available in the market. For example, organic fibres may derive from cellulose, cotton, wood, tea botanical varieties as sub-products, and sub-processed waste, of F&B tea industry. Organic fibres are preferably of a length of about 10 to 400 μm, preferably of about 10 to 200 μm.
3. Organic botanical glycerite; for example about 15 to 55 percent, preferably of about 20 to 35 percent, of botanicals such as Clove, Echinacea sp., Fennel, Ginger, Hawthorn berry, Elderberry, Monarda, Mullein leaves, Nettle, Plantain, Turmeric, Yarrow, and compounds of those.
4. Organic botanical extracts; for example about 1 to 15 percent, preferably of about 2 to 7 percent, of any of the previously referred botanicals, as well as menthol (dl-Menthol, C10H20O, 2-Isopropyl-5-methylcyclohexanol) such as obtained from Chaerophyllum macrospermum, Mesosphaerum sidifolium, or other related botanic varieties, as well as P-menthan-3-ol, as any secondary alcohol as diastereoisomers of 5-methyl-2-(propan-2-yl)cyclohexan-1-ol.

Alternatively, such aerosol-forming substrate may also contain botanical essential oils of about 0.5 to 5 percent, preferably of about 1 to 3 percent, such as of palm, coconut, and wooden-based essential oils.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number “A” is understood as “A” +10 percent of “A”. Within this context, a number “A” may be considered to include numerical values that are within general standard error for the measurement of the property that the number “A” modifies. The number “A”, in some instances as used in the appended claims, may deviate by the percentages enumerated above provided that the amount by which “A” deviates does not materially affect the basic and novel characteristic(s) of the claimed invention. Also, all ranges include the maximum and minimum points disclosed and include any intermediate ranges therein, which may or may not be specifically enumerated herein. The terms “in which” and “wherein” are used synonymously through this specification.

1.-15. (canceled)

16. An aerosol-generating article, comprising:
an aerosol-forming material configured to produce an aerosol;
a first planar layer extending in a first plane; and
a second planar layer extending in a second plane, the second plane being parallel to and spaced from the first plane,
the aerosol-generating article being defined by an article length extending in an x direction, an article width extending in a y direction, and an article thickness extending in a z direction,
wherein the article thickness extends in a direction perpendicular to the first plane and the second plane,
wherein a cavity is defined between the first planar layer and the second planar layer,
wherein an airflow passage is defined through the aerosol-forming article between an air flow inlet and an air flow outlet, the airflow passage extending through the cavity and a height of the cavity being defined by a distance between a lower surface of the first planar layer and an upper surface of the second planar layer,
wherein the article thickness is less than 5 millimetres and a height of the cavity is greater than 50 percent of the article thickness,
wherein an airflow path is defined through the aerosol-generating article from the air flow inlet, through the cavity, and to the air flow outlet,
wherein a resistance to draw (RTD) of the aerosol-generating article, along the airflow path between the air flow inlet and the air flow outlet, is less than 20 millimetres H2O, and
wherein the air flow inlet is defined by an inlet width and an inlet height, and the inlet height is greater than 25 percent of the article thickness.

17. The aerosol-generating article according to claim 16, wherein the article thickness is defined by a distance between an upper surface of the aerosol-generating article and a lower surface of the aerosol-generating article.

18. The aerosol-generating article according to claim 16, wherein the article thickness is defined by a distance between an upper surface of the first planar layer and a lower surface of the second planar layer.

19. The aerosol-generating article according to claim 16, wherein the inlet width is greater than 80 percent of the article width.

20. The aerosol-generating article according to claim 16, wherein the air flow inlet is substantially rectangular.

21. The aerosol-generating article according to claim 16, wherein the height of the cavity is greater than 60 percent of the article thickness.

22. The aerosol-generating article according to claim 16, wherein the article thickness is between 0.5 millimetre and 5 millimetres.

23. The aerosol-generating article according to claim 16, wherein the height of the cavity is between 0.25 millimetre and 4.9 millimetres.

24. The aerosol-generating article according to claim 16, wherein either the first planar layer, the second planar layer, or both first planar layer and the second planar layer comprise the aerosol forming material.

25. The aerosol-generating article according to claim 16, wherein either the first planar layer, the second planar layer, or both first planar layer and the second planar layer comprise a sheet of homogenised tobacco.

26. The aerosol-generating article according to claim 16, wherein either the first planar layer, the second planar layer, or both first planar layer and the second planar layer comprise an aerosol-forming layer comprising aerosol-forming material and at least one further layer.

27. The aerosol-generating article according to claim 26, wherein the at least one further layer is an external layer or a wrapper layer.

28. The aerosol-generating article according to claim 16, wherein the cavity has a width of between 4.75 millimetres and 19.75 millimetres.

29. The aerosol-generating article according to claim 16, wherein the aerosol-generating article has a length of between 10 millimetres and 100 millimetres.

30. The aerosol-generating article according to claim 16, wherein the air flow inlet is defined at a distal end of the aerosol-generating article and the air flow outlet is defined at a proximal end of the aerosol-generating article.

31. The aerosol-generating article according to claim 16, wherein at least some of the aerosol-forming material is located within the cavity.

32. The aerosol-generating article according to claim 16, wherein a plurality of longitudinally extending channels are defined by corrugations of a corrugated element located within the cavity.

33. The aerosol-generating article according to claim 16, further comprising a planar frame positioned between the first planar layer and the second planar layer.

34. The aerosol-generating article according to claim 33, wherein the cavity is defined by a lower surface of the first planar layer, an upper surface of the second planar layer, and internal walls of the planar frame.
